(19) United States
(12) Patent Application Publication
(10) Pub. No.: US 2019/0212629 A1
(43) Pub. Date: Jul. 11, 2019

(54) DUAL FEMTOSECOND OPTICAL FREQUENCY COMB GENERATION DEVICE

(71) Applicant: Beijing Changcheng Institute of Metrology & Measurement,Aviation Industry Corporation of China, Beijing (CN)

(72) Inventors: Tengfei WU, Beijing (CN); Chuanqing XIA, Beijing (CN); Jibo HAN, Beijing (CN); Shuai XING, Beijing (CN)

(21) Appl. No.: 16/103,882

(22) Filed: Aug. 14, 2018

(30) Foreign Application Priority Data
Jan. 9, 2018 (CN) 201810017960.7

(51) Int. Cl. G02F 1/35; H01S 3/00; H01S 3/067

(52) U.S. Cl. CPC G02F 1/353; H01S 3/06791; H01S 3/0092; H01S 3/0078

(57) ABSTRACT

A dual femtosecond optical frequency comb generation device is provided. The device includes a pump source, a wavelength division multiplexer, a piezoelectric ceramic, an erbium doped fiber, a single mode fiber, a first fiber collimating mirror, a second fiber collimating mirror, and spatial optical path elements, a first quarter-wave plate, a first half-wave plate, a polarization beam splitting prism, an optical isolator, a second half-wave plate and a second quarter-wave plate, and further including a grating pair, the grating pair being composed of a first grating and a second grating and being provided between the polarization beam splitting prism and the optical isolator. The device introduces the light distance difference by using the grating pair, so as to generate dual femtosecond optical frequency combs with a difference in repetition frequency, and the repetition frequency difference can be adjusted by the pitch of the grating pair.

### CROSS-REFERENCE TO RELATED APPLICATIONS

This application claims priority to Chinese application no. 201810017960.7 with a filing date of Jan. 19, 2018. The content of the aforementioned application, including any intervening amendments thereto, are incorporated herein by reference.

### TECHNICAL FIELD

The invention relates to a dual femtosecond optical frequency comb generation device, belonging to the field of femtosecond laser technologies.

### BACKGROUND

Femtosecond laser is a series of equally spaced spectral lines in the frequency domain, with line pitch equal to the repetition frequency of femtosecond laser, to form a comb structure, so it is also called a femtosecond optical frequency comb. The femtosecond optical frequency comb has a large spectral range, a narrow line width of spectral lines, and being traceable to a frequency reference, making it ideal for spectral measurement and analysis. In 2005, American scientist Hall and German scientist Hensch won the Nobel Prize in Physics for “the revolutionary research results of laser precision spectroscopy, especially optical frequency comb technology”.

Dual femtosecond optical frequency comb-based dual optical comb spectral measurement technology is a frontier spectroscopy technology, which has received extensive attention from scientists at home and abroad. A dual optical comb spectral measurement requires two femtosecond lasers with slightly different repetition frequencies. One or both of these two femtosecond lasers passes/pass through a sample, and then its/their heterodyne signal/signals is/are acquired using a photodetector. The spectral information of the sample written on the femtosecond optical frequency comb spectral line is transferred to the radio frequency domain, and the spectral information of the sample can be extracted by analyzing the heterodyne signal/signals. The dual optical comb spectral measurement has the advantages of high resolution, high accuracy, high sampling speed and high signal-to-noise ratio. Compared with the traditional Fourier spectrometer, the resolution can be increased by 4 levels of magnitude and the sampling speed can be increased by 6 levels of magnitude. Therefore, the dual optical comb spectral measurement has a great application value in scientific and industrial fields such as molecular fine energy level measurement, atmospheric pollutant monitoring, and engine combustion product detection.

Generating two femtosecond optical frequency combs having small differences in repetition frequency is a prerequisite for the dual optical comb spectral measurement technology. The prior art requires two independent femtosecond optical frequency comb devices, which first greatly increases costs and system volume. Further, the polarization, spectrum and power of the two femtosecond optical frequency combs are independent of each other, which may cause a large difference, affecting the coherence between dual optical combs, and further reducing the signal-to-noise ratio during spectral measurement. In addition, it cannot be guaranteed that environmental factors such as temperature, vibration or airflow, have the same influence on the two independent femtosecond optical frequency comb devices, which reduces the stability of the system. Therefore, the prior art that produces dual femtosecond optical frequency combs constrains the application of dual optical comb spectral measurements.

### SUMMARY OF THE INVENTION

The object of the present invention is to provide a dual femtosecond optical frequency comb generation device in order to solve the existing problems of large volume, complicated structure, poor stability and low coherence between dual femtosecond optical frequency combs caused by generating dual femtosecond optical frequency combs via two devices.

The object of the present invention is achieved by the following technical solutions.

The dual femtosecond optical frequency comb generation device disclosed by the invention has a ring resonant cavity structure composed of optical fibers and a spatial optical path, including a pump source, a wavelength division multiplexer, a piezoelectric ceramic, an erbium doped fiber, a single mode fiber, a first fiber collimating mirror, a second fiber collimating mirror, and spatial optical path elements, a first quarter-wave plate, a first half-wave plate, a polarization beam splitting prism, an optical isolator, a second half-wave plate and a second quarter-wave plate, and further including a grating pair, the grating pair being composed of a first grating and a second grating and being provided between the polarization beam splitting prism and the optical isolator.

The first grating and the second grating are two identical high-density transmissive quartz gratings, having a grating duty ratio of 0.5, the range of grating period a is 2<a<2.15 μm, and the range of grating depth h is 2.65<h<2.72 μm.

The grating pair is perpendicular to the direction of light, the first grating and the second grating are parallel, the grooved surfaces are opposite to each other and are completely symmetrically placed; any one of the gratings is fixed onto a precision nano-displacement device, and can move linearly along the light direction to accurately control the distance between the grating pair.

The pitch of the grating pair is less than or equal to 200 μm.

The wavelength division multiplexer, the erbium doped fiber, the single mode fiber, the first fiber collimating mirror, the second fiber collimating mirror, and the spatial optical path elements, the first quarter-wave plate, the first half-wave plate, the polarization beam splitting prism, the grating pair, the optical isolator, the second half-wave plate, and the second quarter-wave plate, collectively constitute a resonant cavity of the dual femtosecond optical frequency comb generation device; the erbium doped fiber is welded onto the single mode fiber as a gain medium, and except for this, all other fibers in the device are single mode fibers; the optical isolator ensures one-way laser operation within the cavity, and the first quarter-wave plate, the first half-wave plate, the polarization beam splitting prism, the grating pair, the optical isolator, the second half-wave plate, and the second quarter-wave plate are sequentially arranged in a spatial optical path along a light forwarding direction; the pump source is connected to the wavelength division multiplexer for supplying pumping light to the dual femtosecond optical frequency comb generation device; the piezoelectric ceramic is wound with a length of single mode fiber for adjusting a cavity length; the first quarter-wave plate, the half-wave plate, the second half-wave plate, and the second quarter-wave plate realize the mode locking of femtosecond laser pulses of the dual femtosecond optical frequency comb generation device by using a nonlinear polarization rotary mode locking principle; the reflecting port of the polarization beam splitting prism is used for the output of the dual femtosecond optical frequency combs.

The basic principle of the dual femtosecond optical frequency comb generation device is that a light beam within the resonant cavity of the device is diffracted by the grating pair, and the diffracted lights of different levels are transmitted along different paths, forming two laser transmission loops with different optical distances. Each transmission loop corresponds to one particular repetition frequency, thereby causing the device to generate dual femtosecond optical frequency combs with different repetition frequencies.

According to the basic principle of the dual femtosecond optical frequency comb generation device described above, the repetition frequency difference of the dual femtosecond optical frequency combs generated by the device can be adjusted by the pitch of the grating pair.

Beneficial Effect

1) The device of the invention has the advantages of low cost, small volume, simple and compact structure and convenient operation by using a single resonant cavity to simultaneously generate dual femtosecond optical frequency combs by introducing a grating pair;

2) The dual femtosecond optical frequency combs generated by the device of the present invention are derived from a single resonant cavity, which enables the dual femtosecond optical frequency combs to have almost the same polarization, spectrum and power, thereby improving the coherence therebetween, further improving the dual optical comb heterodyne signal signal to noise ratio;

3) Environmental factors such as temperature, vibration, air flow and the like have the same influence on the dual femtosecond optical frequency combs generated by the device of the present invention, the two have the basically same repetition frequency jitter, and it is easy to maintain the stability of the dual optical comb heterodyne signal;

4) The pitch of the grating pair can accurately and conveniently control the repetition frequency difference of the dual femtosecond optical frequency combs; changing the grating depth h can conveniently adjust the relative intensity between the dual femtosecond optical frequency combs, and the whole device has higher flexibility and scalability and richer functions.

### BRIEF DESCRIPTION OF THE DRAWINGS

FIG. 1 is a schematic structural view of a dual femtosecond optical frequency comb generation device;

In the drawings:

1—pump source, 2—wavelength division multiplexer, 3—piezoelectric ceramic, 4—erbium doped fiber, 5—single mode fiber, 6—first fiber collimating mirror, 7—first quarter-wave plate, 8—first half-wave plate, 9—polarization beam splitting prism, 10—grating pair, 11—optical isolator, 12—second half-wave plate, 13—second quarter-wave plate, 14—second fiber collimating mirror, 15—first grating, 16—second grating.

FIG. 2 is a schematic view showing the propagation of laser light through a grating pair;

In the drawing, A is the incident beam, B, C, and D are respectively +1 level diffraction, 0 level diffraction, and −1 level diffraction of A passing through the first grating 15, θ is the diffraction angle, E is −1 level diffraction of B passing through the second grating 16, F is the 0 level diffraction of C passing through the second grating 16, G is the +1 level diffraction of D passing through the second grating 16, a represents the grating period, and h represents the grating depth.

FIG. 3 is a graph showing the relationship between the grating diffraction efficiency and the grating depth.

FIG. 4 is a graph showing the relationship between the frequency difference of the dual femtosecond optical frequency combs and the pitch of the grating pair.

### DETAILED DESCRIPTION

The invention is further illustrated in combination with the following embodiments and drawings, which however should not be construed as limiting the scope of protection of the invention.

### Embodiment 1

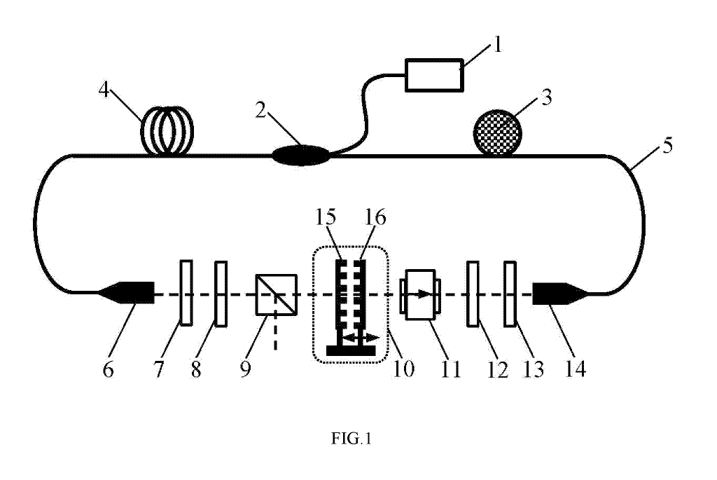

The dual femtosecond optical frequency comb generation device disclosed in this embodiment, as shown in FIG. 1, has a ring resonant cavity structure composed of optical fibers and a spatial optical path, including a pump source 1, a wavelength division multiplexer 2, a piezoelectric ceramic 3, an erbium doped fiber 4, a single mode fiber 5, a first fiber collimating mirror 6, a second fiber collimating mirror 14, and spatial optical path elements, a first quarter-wave plate 7, a first half-wave plate 8, a polarization beam splitting prism 9, an optical isolator 11, a second half-wave plate 12 and a second quarter-wave plate 13, and further including a grating pair 10, the grating pair 10 being composed of a first grating 15 and a second grating 16 and being provided between the polarization beam splitting prism 9 and the optical isolator 11.

The wavelength division multiplexer 2, the erbium doped fiber 4, the single mode fiber 5, the first fiber collimating mirror 6, the second fiber collimating mirror 14, and the spatial optical path elements, the first quarter-wave plate 7, the first half-wave plate 8, the polarization beam splitting prism 9, the grating pair 10, the optical isolator 11, the second half-wave plate 12, and the second quarter-wave plate 13, collectively constitute a resonant cavity of the dual femtosecond optical frequency comb generation device; the erbium doped fiber 4 is welded onto the single mode fiber 5 as a gain medium, and except for this, all other fibers in the device are single mode fibers; the optical isolator 11 ensures one-way laser operation within the cavity, and the first quarter-wave plate 7, the first half-wave plate 8, the polarization beam splitting prism 9, the grating pair 10, the optical isolator 11, the second half-wave plate 12, and the second quarter-wave plate 13 are sequentially arranged in a spatial optical path along a light forwarding direction; the pump source 1 is connected to the wavelength division multiplexer 2 for supplying pumping light to the dual femtosecond optical frequency comb generation device; the piezoelectric ceramic 3 is wound with a length of single mode fiber 5 for adjusting a cavity length; the first quarter-wave plate 7, the half-wave plate 8, the second half-wave plate 12, and the second quarter-wave plate 13 realize the mode locking of femtosecond laser pulses of the dual femtosecond optical frequency comb generation device by using a nonlinear polarization rotary mode locking principle; the reflecting port of the polarization beam splitting prism 9 is used for the output of the dual femtosecond optical frequency combs.

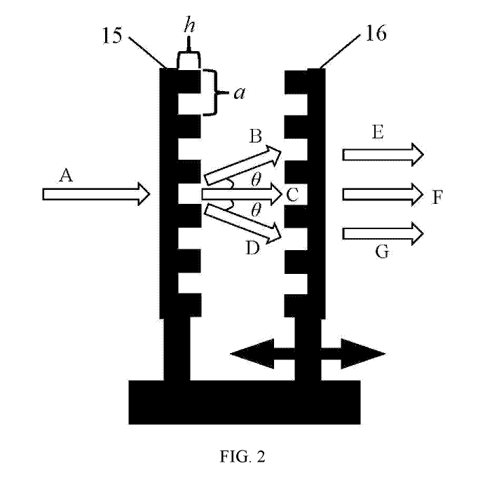

The grating pair 10 is perpendicular to the light forwarding direction, the first grating 15 and the second grating 16 thereof are parallel, the grooved surfaces are opposite to each other and are completely symmetrically placed; the second grating 16 is fixed onto a precision nano-displacement device, and can move linearly along the light direction to accurately control the distance between the grating pair, as shown in FIG. 2.

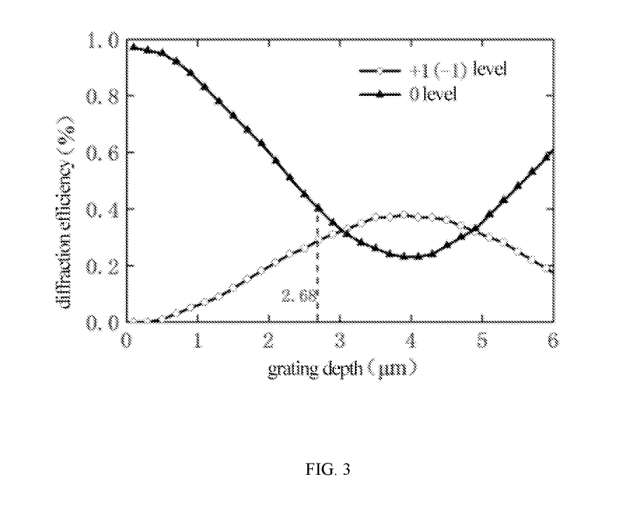

The first grating 15 and the second grating 16 are high-density transmissive quartz gratings having a same period. A quartz grating is fabricated by a microelectronic etching process, and the grating etching depth affects the diffraction efficiency of different levels. The grating duty ratio used in this example is 0.5, and the period a is 2.10 μm. FIG. 3 shows the relationship between the diffraction efficiency and the grating depth. In order to make the two components of the dual femtosecond optical frequency comb have the same intensity, the grating depths h of the first grating 15 and the second grating 16 are both 2.68 μm; their +1 level (−1 level) diffraction efficiency is 28.5%, the diffraction angle θ is 47.6°, and the 0 level diffraction efficiency is 40.3%.

The pitch of the grating pair 10 is controlled to be less than or equal to 200 μm.

The specific principle of the device of the present invention for generating dual femtosecond optical frequency combs is that an incident beam A produces +1 level, 0 level, and −1 level diffraction B, C, D through the first grating 15, B, D and C have light distance difference therebetween, the light distance difference Δl=d/cos θ−d, d is the pitch of the grating pair 10; after passing through the second grating 16, the −1 level diffraction E of B and the +1 level diffraction G of D are parallel with the 0 level diffraction F of C again, as shown in the FIG. 2. Since the pitch of the grating pair is very small, the lateral deviation between E, F, and G is much smaller than the effective aperture of subsequent optical elements, and E, F, and G all participate in the intracavity laser cycle. The beams E and G are in phase, A-B-E and A-D-G collectively form a laser transmission path, and A-C-F form another laser transmission path. Therefore, two paths with different light distances exist within the laser cavity of the dual femtosecond optical frequency comb generation device and can output dual femtosecond optical frequency combs with different repetition frequencies. The relationship between the repetition frequency difference and the light distance difference is Δf=(fᵣ²/c)×Δl, where fᵣ is the repetition frequency when the pitch of the grating pair 10 is 0.

In the dual femtosecond optical frequency comb generation device of the present example, the length of the erbium doped fiber 4 is 50 cm, the total length of the single mode fiber 5 is 130 cm, and the spatial optical path is 30 cm. The device can generate dual femtosecond optical frequency combs of 1550 nm having a repetition frequency near 100 MHz. By turning on the pump source 1, adjusting the orientation of the first quarter-wave plate 7, the first half-wave plate 8, the second half-wave plate 12 and the second quarter-wave plate 13, and using nonlinear polarization rotary mode-locking principle to achieve the mode-locking of femtosecond laser pulses, the reflection port of the polarization beam splitting prism 9 can output dual femtosecond optical frequency combs; a photodetector can be used at the reflection port of the polarization beam splitting prism 9 to detect the repetition frequency difference of the dual femtosecond optical frequency combs.

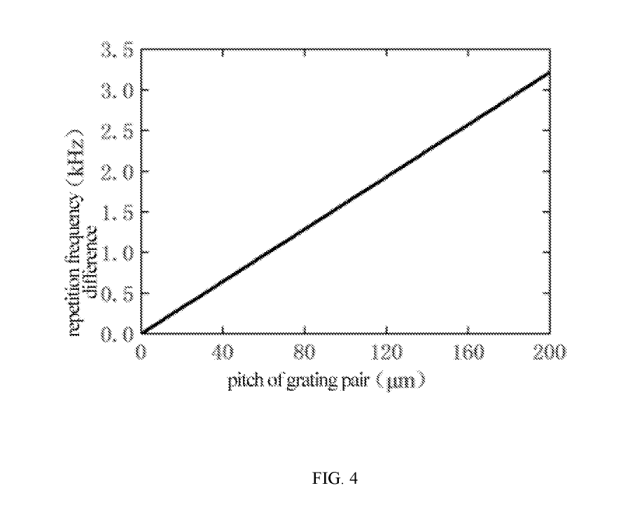

The repetition frequency difference of the dual femtosecond optical frequency combs can be conveniently adjusted by the pitch of the grating pairs 10. When the pitch of the grating pair 10 is varied between 0 and 200 μm, the repetition frequency difference of the dual femtosecond optical frequency combs generated by the device is varied between 0 and 3.2 kHz, and the relationship between the repetition frequency and the pitch of the grating pair is linear, as shown in FIG. 4.

The device of the invention introduces the light distance difference by using the grating pair, and generates dual femtosecond optical frequency combs with a slight difference in repetition frequency through a single device, and has the advantages of small volume, simple and compact structure, and convenient operation. the external environment has the same influence on the dual femtosecond optical frequency combs generated by the device, the system is stable and reliable, and the coherence between the beams is good. The device can be used in frontier fields such as dual optical comb spectral measurements, and has a strong application value.

The above specific description of the present invention further illustrates the object, technical solution and beneficial effects of the invention in detail, and it should be appreciated that the foregoing is merely pertaining to the specific embodiments of the invention and is not intended to limit the scope of protection of the invention. Any modification, equivalent substitution and improvement within the spirit and principle of the invention shall be included within the scope of protection of the invention.

What is claimed is:

1. A dual femtosecond optical frequency comb generation device having a ring resonant cavity structure composed of optical fibers and a spatial optical path, and comprising: a pump source (1), a wavelength division multiplexer (2), a piezoelectric ceramic (3), an erbium doped fiber (4), a single mode fiber (5), a first fiber collimating mirror (6), a second fiber collimating mirror (14), and spatial optical path elements, a first quarter-wave plate (7), a first half-wave plate (8), a polarization beam splitting prism (9), an optical isolator (11), a second half-wave plate (12) and a second quarter-wave plate (13), and characterized by further comprising a grating pair (10), the grating pair (10) being composed of a first grating (15) and a second grating (16) and being provided between the polarization beam splitting prism (9) and the optical isolator (11).

2. The dual femtosecond optical frequency comb generation device according to claim 1, characterized in that the first grating (15) and the second grating (16) are two identical high-density transmissive quartz gratings.

3. The dual femtosecond optical frequency comb generation device according to claim 2, characterized in that the grating duty ratio is 0.5, a grating period a has a range of values of 2<a<2.15 μm, and a grating depth h has a range of values of 2.65<h<2.72 μm.

4. The dual femtosecond optical frequency comb generation device according to claim 1, characterized in that the grating pair (10) is perpendicular to the direction of light, the first grating (15) and the second grating (16) are parallel, the grooved surfaces are opposite to each other and are completely symmetrically placed; the first grating (15) or the second grating (16) is fixed onto a precision nano-displacement device.

5. The dual femtosecond optical frequency comb generation device according to claim 1, characterized in that the pitch of the grating pair (10) is less than or equal to 200 μm.
